(19) United States
(12) Patent Application Publication
(10) Pub. No.: US 2025/0219205 A1
(43) Pub. Date: Jul. 3, 2025

(54) SECONDARY BATTERY

(71) Applicant: SK On Co., Ltd., Seoul (KR)

(72) Inventors: Won Tae HEO, Daejeon (KR); Suk Chan KIM, Daejeon (KR); Soo Min PARK, Daejeon (KR); Hyung Ju PAIK, Daejeon (KR); Hae Ryong JEON, Daejeon (KR); Jin Young BYUN, Gyeonggi-do (KR)

(21) Appl. No.: 18/955,984

(22) Filed: Nov. 22, 2024

(30) Foreign Application Priority Data
Dec. 27, 2023 (KR) 10-2023-0192639

(51) Int. Cl. H01M 50/14; H01M 50/15

(52) U.S. Cl. CPC H01M 50/14; H01M 50/15

(57) ABSTRACT

A secondary battery includes an electrode assembly including a positive electrode, a negative electrode, and a separator isolating the positive electrode and the negative electrode from each other, a battery case having an accommodation space accommodating the electrode assembly and including at least one opening, a cap plate coupled to the battery case to form the accommodation space, and a corner elastic member, having a rod shape, provided to be fixed to each of four corners of the cap plate, and formed of an elastic material.

### CROSS-REFERENCE TO RELATED APPLICATION(S)

This patent document claims the priority and benefits of Korean Patent Application No. 10-2023-0192639 filed on Dec. 27, 2023, the disclosure of which is incorporated herein by reference in its entirety.

### TECHNICAL FIELD

The disclosure and implementations disclosed in this patent document generally relate to a secondary battery.

### BACKGROUND

Secondary batteries, energy storage units that may be charged and discharged, have been widely used in various devices using electricity as a power source, ranging from small devices, such as mobile phones, laptops, and tablets, to large devices, such as vehicles and aircraft. In particular, utilization thereof as a vehicle power source has recently been actively sought.

Secondary batteries may be classified as lead-acid batteries, nickel-cadmium batteries, nickel-hydrogen batteries, lithium-ion batteries, etc., depending on the materials of electrodes and may be appropriately selected depending on the design capacity, usage environment, etc. In particular, lithium-ion batteries, implemented with relatively high voltage and capacity compared to other secondary batteries, have been widely used in fields requiring high-density energy storage units, such as vehicle battery packs.

A secondary battery, such as a lithium-ion battery, includes an electrode assembly and an electrolyte. The electrode assembly may include a positive electrode material (or a cathode material), a negative electrode material (or an anode material), and a separator. The positive electrode material and the negative electrode material are disposed with an insulating separator therebetween, and charging or discharging may be performed by the migration of ions through the electrolyte.

Meanwhile, a protective film disposed on an outer surface of the electrode assembly may be used to prevent a short circuit between the electrode assembly and a case. However, when a strong and irregular external impact load occurs due to an operation of a vehicle or a collision, it may be difficult to expect sufficient stability of the battery, such as a movement of the electrode assembly, and other problems, such as deterioration of the usability of the secondary battery and reduction in the lifespan thereof may occur consequently.

The description is provided to help understand the technical background of the present disclosure and should not be interpreted to reduce, limit, or restrict the technical idea of the present disclosure. In addition, the contents described or suggested in the description do not necessarily mean prior art, and some may include contents that do not correspond to prior art.

### SUMMARY

The present disclosure may be implemented in some

embodiments to provide a secondary battery capable of preventing a movement from being caused by strong and irregularly repeated external impact loads occurring due to an operation of a vehicle or the like.

According to an aspect of the present disclosure, a secondary battery capable of elastically supporting an electrode assembly in a vertical direction may be provided.

However, the technical problems to be achieved by the embodiments of the present disclosure are not necessarily limited to the technical problems mentioned above. Other technical problems not mentioned may be clearly understood by those skilled in the art to which the present disclosure pertains from other descriptions of the specification, such as the detailed description.

The secondary battery of the present disclosure may be widely applied in green technology fields, such as electric vehicles, battery charging stations, and solar power generation and wind power generation using batteries. In addition, the secondary battery of the present disclosure may be used in eco-friendly electric vehicles, hybrid vehicles, etc. to ameliorate the effects of climate change by suppressing air pollution and greenhouse gas emissions.

In some embodiments of the present disclosure, a secondary battery includes: an electrode assembly including a positive electrode, a negative electrode, and a separator isolating the positive electrode and the negative electrode from each other; a battery case having an accommodation space accommodating the electrode assembly and including at least one opening; a cap plate coupled to the battery case to form the accommodation space; and a corner elastic member, having a rod shape, provided to be fixed to each of four corners of the cap plate, and formed of an elastic material.

The corner elastic body may include a first corner elastic body, and the corner elastic body may have a shape and size corresponding to a space occurring between the electrode assembly and an internal corner wall of the battery case. The first corner elastic body may include a 1-1 planar portion which is a short section in a first direction, a 1-2planar portion which is a short section in a second direction, a first corner portion which is a bent section between the 1-1 planar portion and the 1-2 planar portion, and a first curved portion which is a curved section between the 1-1 planar portion and the 1-2 planar portion. When the electrode assembly fitted into the first corner elastic body is entirely inserted into the battery case, the 1-1 planar portion and the 1-2 planar portion may be in close contact with the inner wall surface near the corner of the battery case, the first corner portion may be in close contact with the corner of the battery case, and the first curved portion may be in close contact with a round corner of the electrode assembly.

The corner elastic body may include a second corner elastic body, and the second corner elastic body may include a 2-1 planar portion which is a short section in the first direction, a 2-2 planar portion which is a long section in the second direction, a second corner portion which is a bent section between the 2-1 planar portion and the 2-2planar portion, and a pair of second curved portions which are curved sections between the 2-1 planar portion and the 2-2 planar portion. When the electrode assembly fitted into the second corner elastic body is entirely inserted into the battery case, the 2-1 planar portion and the 2-2 planar portion may be in close contact with the inner wall surface near the corner of the battery case, the second corner portion may be in close contact with the corner of the battery case, and the second curved portion may be in close contact with a round corner of the electrode assembly.

The corner elastic body may include a third corner elastic body, and the third corner elastic body may include a 3-1 planar portion which is a short section in the first direction, a 3-2 planar portion which is a long section in the second direction, a third corner portion which is a bent section between the 3-1 planar portion and the 3-2 planar portion, a pair of third curved portions which are curved sections between the 3-1 planar portion and the 3-2 planar portion, and an inclined portion cut toward the end. The inclined portion may have a function to facilitate initial insertion when the third corner elastic body with the electrode assembly fitted therein is inserted into the battery case. When the electrode assembly fitted into the third corner elastic body is entirely inserted into the battery case, the 3-1 planar portion and the 3-2 planar portion may be in close contact with the inner wall surface near the corner of the battery case, the third corner portion may be in close contact with the corner of the battery case, and the third curved portion may be in close contact with a round corner of the electrode assembly.

The corner elastic body may include a fourth corner elastic body, and the fourth corner elastic body may include a 4-1 planar portion which is a short section in the first direction, a 4-2 planar portion which is a long section in the second direction, a fourth corner portion which is a bent section between the 4-1 planar portion and the 4-2planar portion, a pair of fourth curved portions which are curved sections between the 4-1 planar portion and the 4-2planar portion, and an uneven portion which is a section in which depressions and protrusions are densely formed on an internal surface of the fourth curved portion. The uneven portion may have a function of increasing adhesion to facilitate insertion when the fourth corner elastic body with the electrode assembly fitted therein is inserted into the battery case. When the electrode assembly fitted into the fourth corner elastic body is entirely inserted into the battery case with, the 4-1 planar portion and the 4-2 planar portion may be in close contact with the inner wall surface near the corner of the battery case, the fourth corner portion may be in close contact with the corner of the battery case, and the fourth curved portion may be in close contact with a round corner of the electrode assembly. In some embodiments of the present disclosure, a

secondary battery includes: an electrode assembly including a positive electrode, a negative electrode, and a separator, and wherein a positive electrode tab electrically connected to the positive electrode and a negative electrode tab electrically connected to the negative electrode are provided to protrude; a cap plate in which a vent is formed, a positive electrode terminal and a negative electrode terminal are provided on both sides of the vent, and an electrolyte injection port is formed between the vent and the positive electrode terminal or between the vent and the negative electrode terminal; a fifth corner elastic body having a rod shape and formed of an elastic material; a bottom elastic body including an elastic support plate provided so that the fifth corner elastic body is fixed to four corners in a vertical direction; and a battery case in which an internal space is secured in which the electrode assembly and an electrolyte are accommodated together and an upper end of the battery case is open to form an opening.

The fifth corner elastic body includes a 5-1 planar portion which is a short section in the first direction, a 5-2 planar portion which is a short section in the second direction, a fifth corner portion which is a bent section between the 5-1 planar portion and the 5-2 planar portion, and a fifth curved portion which is a curved section between the 5-1 planar portion and the 5-2 planar portion. When the electrode assembly fitted into the fifth corner elastic body is entirely inserted into the battery case, the 5-1 planar portion and the 5-2 planar portion may be in close contact with the inner wall surface near the corner of the battery case, the fifth corner portion may be in close contact with the corner of the battery case, and the fifth curved portion may be in close contact with a round corner of the electrode assembly. The elastic support plate may be curved to be convex upwardly to elastically support the electrode assembly toward the cap plate. The bottom elastic body may further include an electrolyte inlet hole, an arc debris movement path, and an arc debris storage recess.

The electrolyte inlet hole may be provided in plural and the plurality of electrolyte inlet holes are formed evenly in a perforated manner across the entire surface of the elastic support plate. The arc debris movement path may be formed in a groove shape extending in a first direction on an upper surface of the elastic support plate. The arc debris storage recess may be provided in a corner of the elastic support plate in which the fifth corner elastic body is provided.

### BRIEF DESCRIPTION OF DRAWINGS

Certain aspects, features, and advantages of the present disclosure are illustrated by the following detailed description with reference to the accompanying drawings.

FIG. 1 is a full perspective view of a secondary battery according to one embodiment of the present disclosure;

FIG. 2 is a partially exploded perspective view of the secondary battery of FIG. 1;

FIG. 3 is an enlarged perspective view of a cap plate and a corner elastic body of FIG. 2;

FIG. 4 is a cross-sectional view of a battery case to which the cap plate and the corner elastic body of FIG. 3 are applied, an electrode assembly, and the corner elastic body;

FIG. 5 is an enlarged perspective view of a cap plate and a corner elastic body according to a modified example of the present disclosure;

FIG. 6 is a cross-sectional view of a battery case to

which the cap plate and the corner elastic body of FIG. 5 are applied, an electrode assembly, and the corner elastic body;

FIG. 7 is an enlarged perspective view of a cap plate and a corner elastic body according to another modified example of the present disclosure;

FIG. 8 is a cross-sectional view of a battery case to which the cap plate and the corner elastic body of FIG. 7 are applied, an electrode assembly, and the corner elastic body;

FIG. 9 is an enlarged perspective view of a cap plate and a corner elastic body according to another modified example of the present disclosure;

FIG. 10 is a cross-sectional view of a battery case to which the cap plate and the corner elastic body of FIG. are applied, an electrode assembly, and the corner elastic body;

FIG. 11 is an exploded perspective view of a secondary

battery having a function of preventing a movement and elastically supporting an electrode assembly;

FIG. 12 is an enlarged perspective view of a corner elastic body and a bottom elastic body of FIG. 11;

FIG. 13 is a cross-sectional view illustrating that an electrode assembly fitted into a corner elastic body is inserted into a battery case; and

FIG. 14 is a longitudinal cross-sectional view illustrating that an electrode assembly fitted into a corner elastic body is inserted into a battery case.

### DETAILED DESCRIPTION

Hereinafter, a secondary battery having a function of preventing a movement of an electrode assembly according to an embodiment of the present disclosure will be described with reference to the attached drawings.

First, a secondary battery having a function of

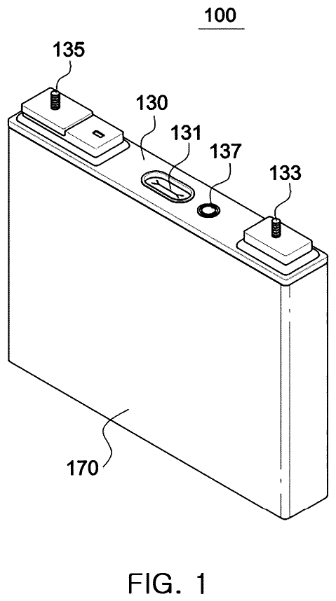

preventing a movement of an electrode assembly will be specifically described with reference to FIGS. 1 to 10.

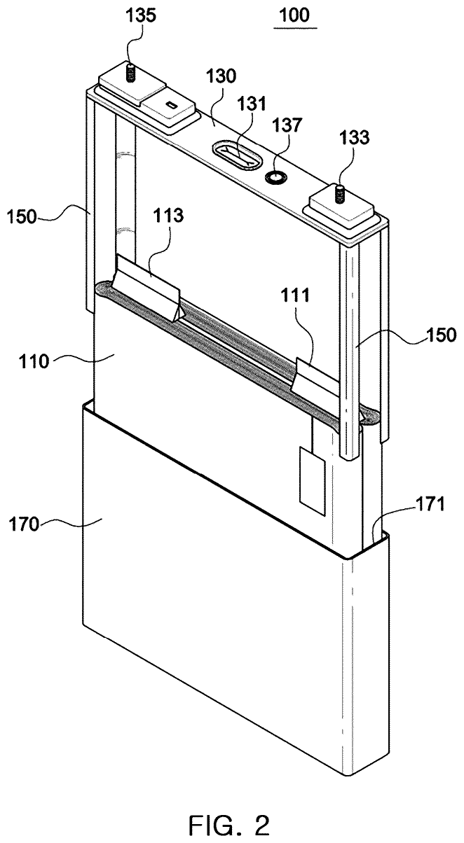

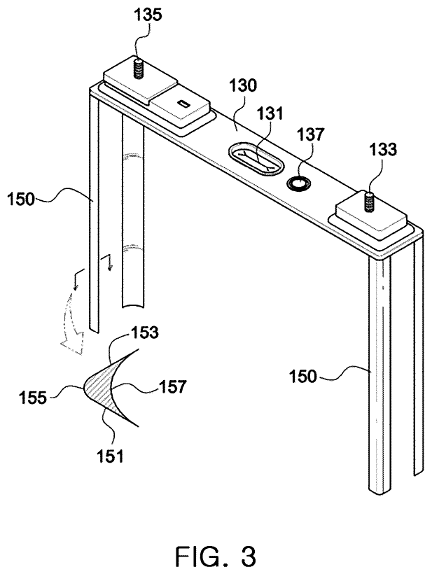

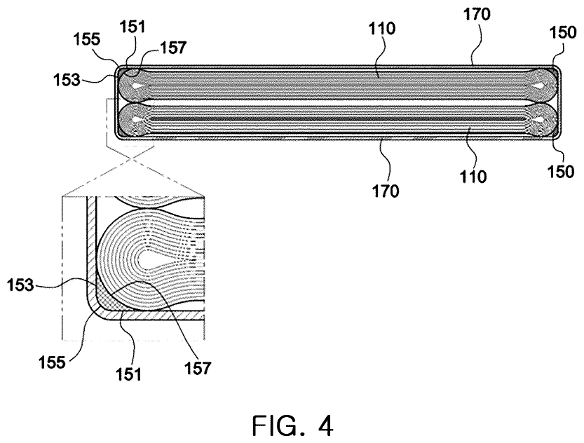

FIG. 1 is a full perspective view of a secondary battery according to one embodiment of the present disclosure, FIG. 2 is a partially exploded perspective view of the secondary battery of FIG. 1, FIG. 3 is an enlarged perspective view of a cap plate and a corner elastic body of FIG. 2, and FIG. 4 is a cross-sectional view of a battery case to which the cap plate and the corner elastic body of FIG. 3 are applied, an electrode assembly, and the corner elastic body.

As illustrated in FIGS. 1 to 4, a secondary battery 100 of the present embodiment may include an electrode assembly 110, a cap plate 130, a first corner elastic body 150, and a battery case 170.

The electrode assembly 110 may include a positive electrode, a negative electrode, and a separator, although not shown. The electrode assembly 110 may be formed as a structure in which the positive electrode, the negative electrode, and the separator are wound around a longitudinal or transverse axis, which is mainly referred to as a “jelly roll”.

The positive electrode may include a positive electrode current collector and a positive electrode active material. The positive electrode current collector may include aluminum, an aluminum alloy, etc., and the positive electrode active material may include lithium cobalt oxide, lithium manganese oxide, lithium nickel oxide, lithium iron phosphate, etc.

The positive electrode current collector may have a

positive electrode active material applied to a portion of a surface thereof, and the remaining portion of the surface in which the positive electrode active material is not applied may be a positive electrode tab 111. Here, a plurality of positive electrode tabs 111 may be provided, and some or all of the plurality of positive electrode tabs 111 may be mutually bonded.

The negative electrode may include a negative electrode current collector and a negative electrode active material. The negative electrode current collector may include copper, copper alloy, nickel, nickel alloy, etc., and the negative electrode active material may include carbon, silicon, etc.

The negative electrode active material may be applied to a portion of a surface region of the negative electrode current collector, and the remaining region of the negative electrode current collector in which the negative electrode active material is not applied may be a negative electrode tab 113. Here, a plurality of negative electrode tabs 113 may be provided, and some or all of the plurality of negative electrode tabs 113 may be mutually bonded.

The separator is provided to be located between the positive electrode and the negative electrode, limits physical contact between the positive electrode and the negative electrode, and provides a passage for the migration of ions.

In addition, the separator may be formed of a polymer material including polyethylene, polypropylene, etc. and may include a dry and wet separator or a coating layer, such as a ceramic coating layer.

The cap plate 130 is provided with a vent 131 in the center, a positive electrode terminal 133 and a negative electrode terminal 135 are provided on both sides of the vent 131, and an electrolyte injection port 137 may be formed between the vent 131 and the positive electrode terminal 133.

Here, the positive electrode terminal 133 and the negative electrode terminal 135 may be interchanged, and the positions of the vent 131 and the electrolyte injection port 137 may also be changed.

The vent 131 is formed to be opened in response to

internal pressure of the battery case 170 so that the internal pressure of the battery case 170 may be discharged externally in order to stabilize the internal components of the battery case 170.

The positive electrode terminal 133 is provided in a position electrically connected to the positive electrode tab 111 of the electrode assembly 110, and the negative electrode terminal 135 is provided in a position electrically connected to the negative electrode tab 113 of the electrode assembly 110. When the positions of the positive electrode terminal 133 and the negative electrode terminal 135 are changed, the positions of the positive electrode tab 111 and the negative electrode tab 113 are also changed correspondingly.

The electrolyte injection port 137 is used to inject electrolyte into an internal space of the battery case 170. In the present embodiment, the electrolyte injection port 137 is disposed to be adjacent to the vent 131, but the position of the electrolyte injection port 137 may vary. In addition, the electrolyte injection port 137 may be appropriately sealed after the electrolyte injection, a chemical reaction process, etc., and a ball-shaped sealing member formed of a polymer resin may be pressed to seal the electrolyte injection port 137

The corner elastic body may include a first corner

elastic body 150. The first corner elastic body 150 is provided to be fixed to each of the four corners of the cap plate 130. The first corner elastic body 150 may have a rod shape, may have a length equal to a height of the electrode assembly 110, and may be formed of a non-metallic material having excellent elasticity.

In addition, the first corner elastic body 150 may have a shape and size corresponding to a space occurring between the electrode assembly 110 and an internal corner wall surface of the battery case 170. Due to this, when the electrode assembly 110 is accommodated in the battery case 170 together with an electrolyte, the empty space occurring between the electrode assembly 110 and the internal corner of the battery case 170 may be filled with the first corner elastic body 150, so that a movement of the electrode assembly 110 may be prevented against external strong and irregularly repeated impact loads that may occur due to an operation of a vehicle, etc.

The first corner elastic body 150 may have a 1-1 planar portion 151 which is a short section in a first direction in the drawing, a 1-2 planar portion 153 which is a short section in a second direction, a first corner portion 155 which is a bent section between the 1-1 planar portion 151 and the 1-2 planar portion 153, and a first curved portion 157 which is a curved section between the 1-1 planar portion 151 and the 1-2 planar portion 153.

When the electrode assembly 110 fitted into the first corner elastic body 150 is entirely inserted into the battery case 170, as shown in FIG. 4, the 1-1 planar portion 151 and the 1-2 planar portion 153 may be in close contact with an inner wall surface near the corner of the battery case 170, the first corner portion 155 may be in close contact with the corner of the battery case 170, the first curved portion 157 may be in close contact with the round corner of the electrode assembly 110.

The battery case 170 has an internal space in which the electrode assembly 110 and the electrolyte are accommodated together, and the top is open to form an opening 171. The electrolyte may be formed of an organic solvent including a lithium salt, and for example, the lithium salt may include lithium hexafluorophosphate (LiPF₆) in a liquid or gel form, lithium tetrafluoroborate (LiBF₄), etc., and the organic solvent may include a cyclic carbonate, such as ethylene carbonate (EC) or propylene carbonate (PC), a linear carbonate, such as diethyl carbonate (DEC), dimethyl carbonate (DMC), or ethyl methyl carbonate (EMC), etc.

The battery case 170 has the opening 171 completely closed by the cap plate 130. To this end, the opening 171 of the battery case 170 and the cap plate 130 are formed to correspond in shape and size to each other, and the cap plate 130 is welded to the top of the battery case 170 by ultrasonic welding, laser welding, etc. for complete closure.

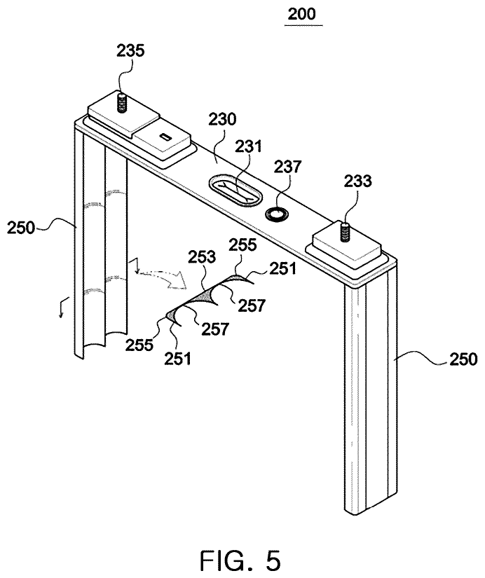

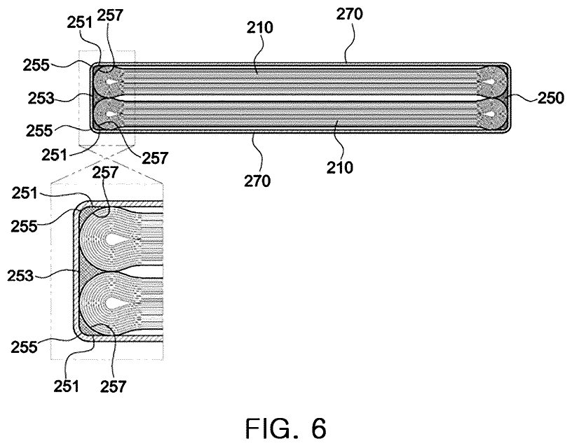

Next, a modified example of the corner elastic body according to the present disclosure will be described with reference to FIGS. 5 and 6. FIG. 5 is an enlarged perspective view of a cap plate and a corner elastic body according to a modified example of the present disclosure, and FIG. 6 is a cross-sectional view of a battery case to which the cap plate and the corner elastic body of FIG. 5 are applied, an electrode assembly, and the corner elastic body.

A cap plate 230 may have a vent 231 provided in the center, a positive electrode terminal 233 and a negative electrode terminal 235 may be provided on both sides of the vent 231, and an electrolyte injection port 237 may be formed between the vent 231 and the positive electrode terminal 233. Here, the positive electrode terminal 233 and the negative electrode terminal 235 may be interchanged, and the positions of the vent 231 and the electrolyte injection port 237 may also be changed.

The vent 231 is formed to be opened in response to internal pressure of the battery case (170 of FIG. 2) so that the internal pressure of the battery case (170 of FIG. 2) may be discharged externally in order to stabilize the internal components of the battery case (170 of FIG. 2).

The positive electrode terminal 233 is provided in a position electrically connected to the positive electrode tab (111 of FIG. 2) of the electrode assembly (110 of FIG. 2), and the negative electrode terminal 235 is provided in a position electrically connected to the negative electrode tab (113 of FIG. 2) of the electrode assembly (110 of FIG. 2). When the positions of the positive electrode terminal 233 and the negative electrode terminal 235 are changed, the positions of the positive electrode tab (111 of FIG. 2) and the negative electrode tab (113 of FIG. 2) are also changed correspondingly.

The electrolyte injection port 237 is used to inject the electrolyte into the internal space of the battery case (170 in FIG. 2). In the present embodiment, the electrolyte injection port 237 is disposed to be adjacent to the vent 231, but the position of the electrolyte injection port 237 may vary. In addition, the electrolyte injection port 237 may be appropriately sealed after the electrolyte injection, a chemical reaction process, etc., and a ball-shaped sealing member formed of a polymer resin may be pressed to seal the electrolyte injection port 237.

The corner elastic body may include a second corner elastic body 250. The second corner elastic body 250 is provided to be fixed to each of the four corners of the cap plate 230. The second corner elastic body 250 may have a rod shape, may have a length equal to the height of the electrode assembly (110 in FIG. 2), and may be formed of a non-metallic material with excellent elasticity.

In addition, the second corner elastic body 250 may have a shape and size corresponding to the space occurring between the electrode assembly (110 of FIG. 2) and the internal corner wall surface of the battery case (170 of FIG. 2). Due to this, when the electrode assembly (110 of FIG. 2) is accommodated in the battery case (170 of FIG. 2) together with the electrolyte, the empty space occurring between the electrode assembly (110 of FIG. 2) and the internal corner of the battery case (170 of FIG. 2) may be filled with the second corner elastic body 250, so that a movement of the electrode assembly (110 of FIG. 2) may be prevented against an external strong and irregularly repeated impact loads that may occur due to an operation of a vehicle, etc.

The second corner elastic body 250 may have a 2-1 planar portion 251 which is a short section in the first direction in the drawing, a 2-2 planar portion 253 which is a long section in the second direction, a second corner portion 255 which is a bent section between the 2-1 planar portion 251 and the 2-2 planar portion 253, and a pair of second curved portions 257 which are curved sections between the 2-1 planar portion 251 and the 2-2 planar portion 253.

When the electrode assembly 110 fitted into the second corner elastic body 250 is entirely inserted into the battery case 170, as shown in FIG. 6, the 2-1 planar portion 251 and the 2-2 planar portion 253 may be in close contact with the inner wall surface near the corner of the battery case 170, the second corner portion 255 may be in close contact with the corner of the battery case 170, and the second curved portion 257 may be in close contact with the round corner of the electrode assembly 110.

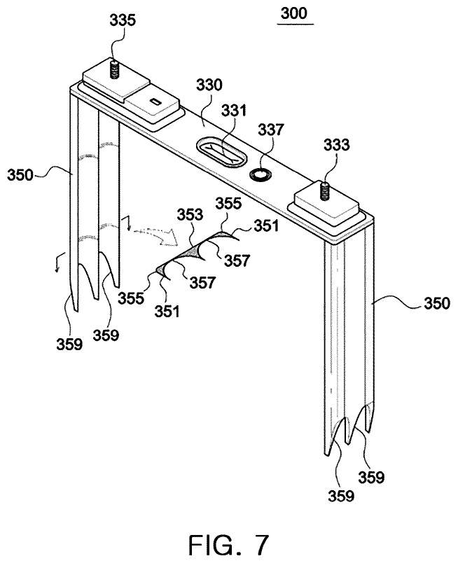

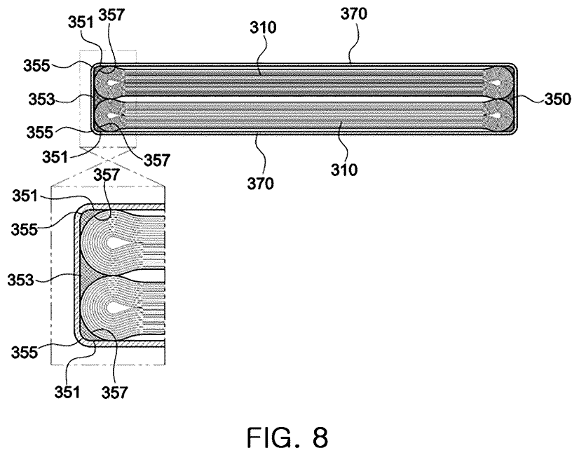

Next, another modified example of the corner elastic body according to the present disclosure will be described with reference to FIGS. 7 and 8. FIG. 7 is an enlarged perspective view of a cap plate and a corner elastic body according to another modified example of the present disclosure, and FIG. 8 is a cross-sectional view of a battery case to which the cap plate and the corner elastic body of FIG. 7 are applied, an electrode assembly, and the corner elastic body.

A cap plate 330 may have a vent 331 provided in the center, a positive electrode terminal 333 and a negative electrode terminal 335 may be provided on both sides of the vent 331, and an electrolyte injection port 337 may be formed between the vent 331 and the positive electrode terminal 333. Here, the positive electrode terminal 333 and the negative electrode terminal 335 may be interchanged, and the positions of the vent 331 and the electrolyte injection port 337 may also be changed.

The vent 331 is formed to be opened in response to internal pressure of the battery case (170 of FIG. 2) so that the internal pressure of the battery case (170 of FIG. 2) may be discharged externally in order to stabilize the internal components of the battery case (170 of FIG. 2).

The positive electrode terminal 333 is provided in a position electrically connected to the positive electrode tab (111 of FIG. 2) of the electrode assembly (110 of FIG. 2), and the negative electrode terminal 335 is provided in a position electrically connected to the negative electrode tab (113 of FIG. 2) of the electrode assembly (110 of FIG. 2). When the positions of the positive electrode terminal 333 and the negative electrode terminal 335 are changed, the positions of the positive electrode tab (111 of FIG. 2) and the negative electrode tab (113 of FIG. 2) are also changed correspondingly.

The electrolyte injection port 337 is used to inject electrolyte into the internal space of the battery case (170 of FIG. 2). In the present embodiment, the electrolyte injection port 337 is disposed to be adjacent to the vent 331, but the position of the electrolyte injection port 337 may vary. In addition, the electrolyte injection port 337 may be appropriately sealed after the electrolyte injection, the chemical reaction process, etc., and a ball-shaped sealing member formed of a polymer resin may be pressed to seal the electrolyte injection port 337.

The corner elastic body may include a third corner elastic body 350. The third corner elastic body 350 is provided to be fixed to each of the four corners of the cap plate 330. The third corner elastic body 350 may have a rod shape, may have a length equal to the height of the electrode assembly (110 of FIG. 2), and may be formed of a non-metallic material with excellent elasticity.

In addition, the third corner elastic body 350 may have a shape and size corresponding to the space occurring between the electrode assembly (110 of FIG. 2) and the internal corner wall surface of the battery case (170 of FIG. 2). Due to this, when the electrode assembly (110 of FIG. 2) is accommodated in the battery case (170 of FIG. 2) together with the electrolyte, the empty space occurring between the electrode assembly (110 of FIG. 2) and the internal corner of the battery case (170 of FIG. 2) may be filled with the third corner elastic body 350, so that a movement of the electrode assembly (110 of FIG. 2) may be prevented against external strong and irregularly repeated impact loads that may occur due to an operation of a vehicle, etc.

The third corner elastic body 350 may have a 3-1 planar portion 351 which is a short section in the first direction in the drawing, a 3-2 planar portion 353 which is a long section in the second direction, a third corner portion 355 which is a bent section between the 3-1 planar portion 351 and the 3-2 planar portion 353, a pair of third curved portions 357 which are curved sections between the 3-1 planar portion 351 and the 3-2 planar portion 353, and an inclined portion 359 cut toward the end. The inclined portion 359 functions to facilitate initial insertion when the third corner elastic body 350 into which the electrode assembly (110 of FIG. 2) is fitted is inserted into the battery case (170 of FIG. 2).

When the electrode assembly 110 fitted into the third corner elastic body 350 is entirely inserted into the battery case 170, as shown in FIG. 8, the 3-1 planar portion 351 and the 3-2 planar portion 353 may be in close contact with the inner wall surface near the corner of the battery case 170, the third corner portion 355 may be in close contact with the corner of the battery case 170, and the third curved portion 357 may be in close contact with the round corner of the electrode assembly 110.

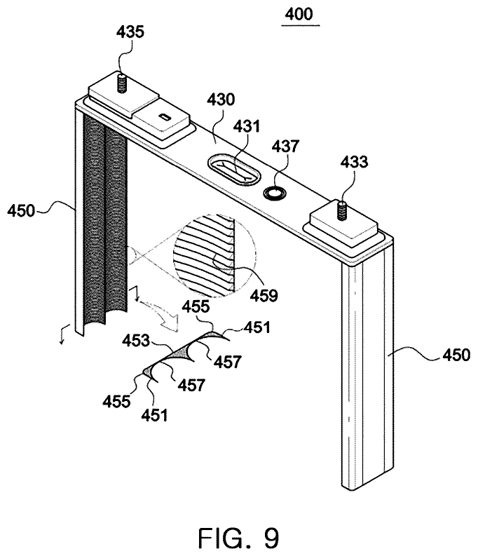

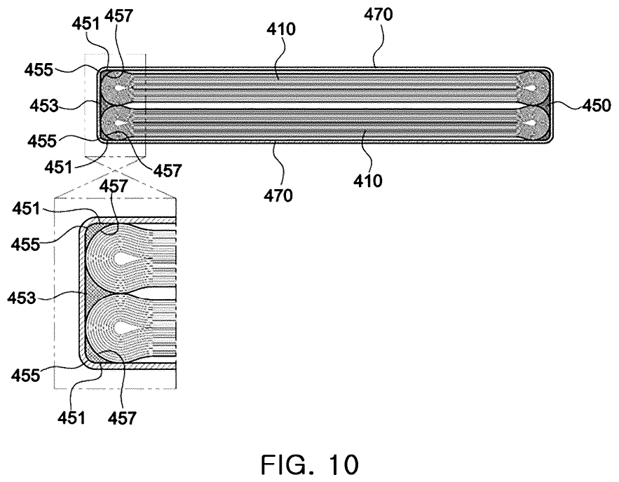

Next, another modified example of the corner elastic body according to the present disclosure will be described with reference to FIGS. 9 and 10. FIG. 9 is an enlarged perspective view of a cap plate and a corner elastic body according to another modified example of the present disclosure, and FIG. 10 is a cross-sectional view of a battery case to which the cap plate and the corner elastic body of FIG. 9 are applied, an electrode assembly, and the corner elastic body.

A cap plate 430 may have a vent 431 provided in the center, a positive electrode terminal 433 and a negative electrode terminal 435 may be provided on both sides of the vent 431, and an electrolyte injection port 437 may be formed between the vent 431 and the positive electrode terminal 433. Here, the positive electrode terminal 433 and the negative electrode terminal 435 may be interchanged, and the positions of the vent 431 and the electrolyte injection port 437 may also be changed.

The vent 431 is formed to be opened in response to internal pressure of the battery case (170 of FIG. 2) so that the internal pressure of the battery case (170 of FIG. 2) may be discharged externally in order to stabilize the internal components of the battery case (170 of FIG. 2).

The positive electrode terminal 433 is provided in a position electrically connected to the positive electrode tab (111 of FIG. 2) of the electrode assembly (110 of FIG. 2), and the negative electrode terminal 435 is provided in a position electrically connected to the negative electrode tab (113 of FIG. 2) of the electrode assembly (110 of FIG. 2). When the positions of the positive electrode terminal 433 and the negative electrode terminal 435 are changed, the positions of the positive electrode tab (111 of FIG. 2) and the negative electrode tab (113 of FIG. 2) also change correspondingly.

The electrolyte injection port 437 is used to inject electrolyte into the internal space of the battery case (170 in FIG. 2). In the present embodiment, the electrolyte injection port 437 is disposed to be adjacent to the vent 431, but the position of the electrolyte injection port 437 may vary. In addition, the electrolyte injection port 437 may be appropriately sealed after the electrolyte injection, the chemical reaction process, etc., and a ball-shaped sealing member formed of a polymer resin may be pressed to seal the electrolyte injection port 437.

The corner elastic body may include a fourth corner elastic body 450. The fourth corner elastic body 450 is provided to be fixed to each of the four corners of the cap plate 430. The fourth corner elastic body 450 has a rod shape, may have a length equal to the height of the electrode assembly (110 in FIG. 2), and may be formed of a non-metallic material with excellent elasticity.

In addition, the fourth corner elastic body 450 may have a shape and size corresponding to the space occurring between the electrode assembly (110 of FIG. 2) and the internal corner wall surface of the battery case (170 of FIG. 2). Due thereto, when the electrode assembly (110 of FIG. 2) is accommodated in the battery case (170 of FIG. 2) together with an electrolyte, the empty space occurring between the electrode assembly (110 of FIG. 2) and the internal corner of the battery case (170 of FIG. 2) may be filled with the fourth corner elastic body 450, so that a movement of the electrode assembly (110 of FIG. 2) may be prevented against an external strong and irregularly repeated impact loads that may occur due to an operation of a vehicle, etc.

The fourth corner elastic body 450 may have a 4-1 planar portion 451 which is a short section in the first direction in the drawing, a 4-2 planar portion 453 which is a long section in the second direction, a fourth corner portion 455 which is a bent section between the 4-1 planar portion 451 and the 4-2 planar portion 453, a pair of fourth curved portions 457 which are curved sections between the 4-1 planar portion 451 and the 4-2 planar portion 453, and an uneven portion 459 which is a section in which depressions and protrusions are densely formed on an internal surface of the fourth curved portion 457. The uneven portion 459 functions to increase adhesion to facilitate insertion when the fourth corner elastic body 450 with the electrode assembly (110 of FIG. 2) fitted therein is inserted into the battery case (170 of FIG. 2).

When the electrode assembly 110 fitted into the fourth corner elastic body 450 is entirely inserted into the battery case 170, as shown in FIG. 10, the 4-1 planar portion 451 and the 4-2 planar portion 453 may be in close contact with the inner wall surface near the corner of the battery case 170, the fourth corner portion 455 may be in close contact with the corner of the battery case 370, and the fourth curved portion 457 may be in close contact with the round corner of the electrode assembly 110.

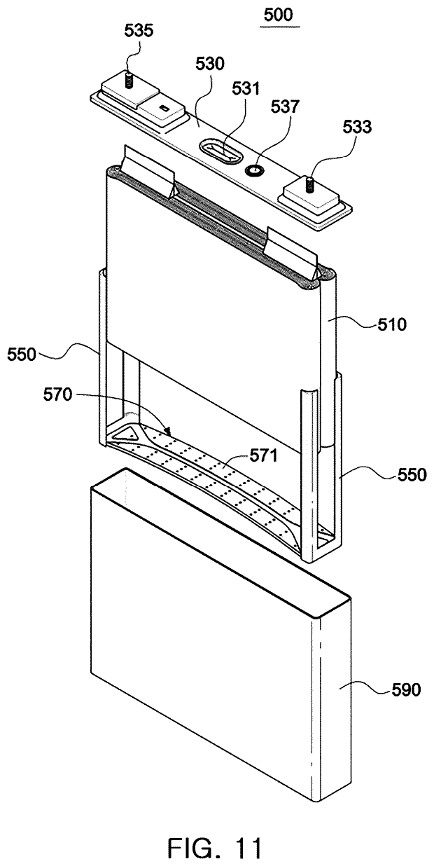

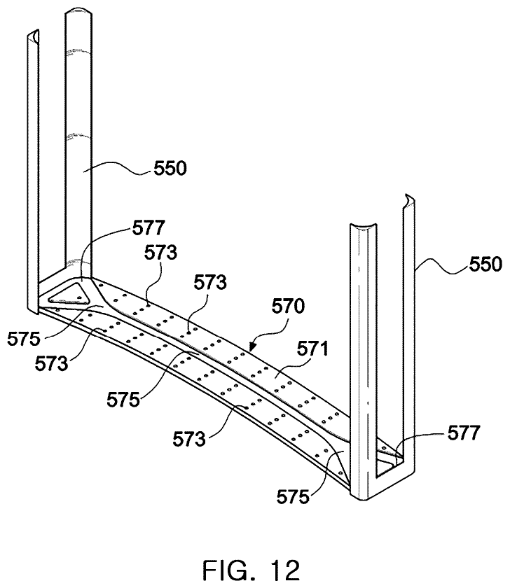

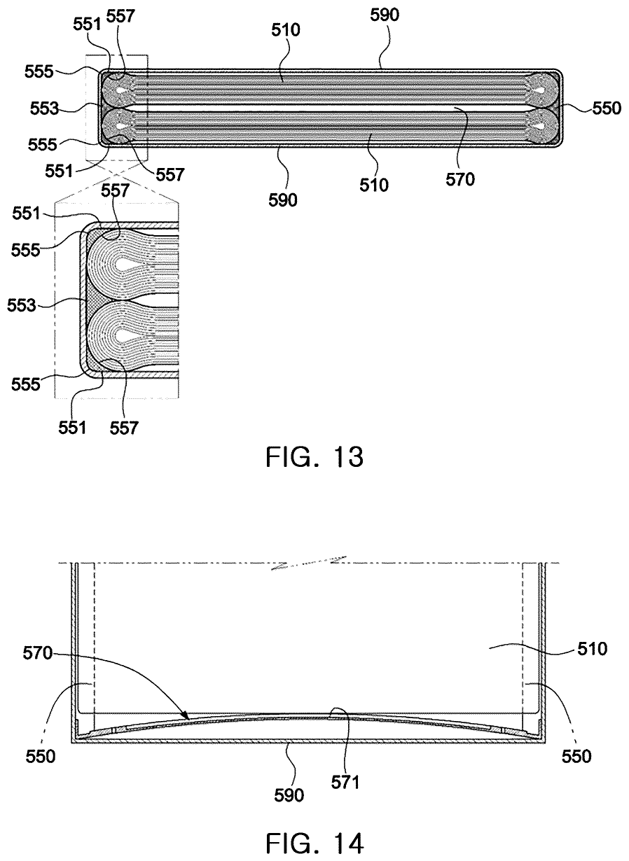

Next, a secondary battery having a function of preventing a movement and elastically supporting the electrode assembly of the present disclosure is specifically described with reference to FIGS. 11 to 14. FIG. 11 is an exploded perspective view of a secondary battery having the function of preventing a movement and elastically supporting an electrode assembly, FIG. 12 is an enlarged perspective view of a corner elastic body and a bottom elastic body of FIG. 11, FIG. 13 is a cross-sectional view illustrating that an electrode assembly fitted into a corner elastic body is inserted into a battery case, and FIG. 14 is a longitudinal cross-sectional view illustrating that an electrode assembly fitted into a corner elastic body is inserted into a battery case.

As illustrated in FIGS. 11 and 12, a secondary battery 500 of the present embodiment may include an electrode assembly 510, a cap plate 530, a fifth corner elastic body 550, a bottom elastic body 570, and a battery case 590.

The electrode assembly 510, the cap plate 530, and the battery case 590 are substantially the same as the configuration of the electrode assembly 110, the cap plate 130, and the battery case 170 described above with reference to FIGS. 1 and 2, so a detailed description thereof will be omitted.

The corner elastic body may include a fifth corner elastic body 550. The fifth corner elastic body 550 may have a rod shape, may have a length equal to a height of the electrode assembly 510, and may be formed of a non-metallic material with excellent elasticity.

In addition, the fifth corner elastic body 550 may have a shape and size corresponding to the space occurring between the electrode assembly 510 and an internal corner wall surface of the battery case 590. Due to this, when the electrode assembly 510 is accommodated in the battery case 590 together with an electrolyte, the empty space occurring between the electrode assembly 510 and the internal corner of the battery case 590 may be filled with the fifth corner elastic body 550, so that a movement of the electrode assembly 510 may be prevented against external strong and irregularly repeated impact loads that may occur due to an operation of a vehicle, etc.

The fifth corner elastic body 550 may have a 5-1 planar portion 551 which is a short section in the first direction, a 5-2 planar portion 553 which is a short section in the second direction, a fifth corner portion 555 which is a bent section between the 5-1 planar portion 551 and the 5-2 planar portion 553, and a fifth curved portion 557 which is a curved section between the 5-1 planar portion 551 and the 5-2 planar portion 553.

When the electrode assembly 510 fitted into the fifth corner elastic body 550 is entirely inserted into the battery case 590, as shown in FIG. 13, the 5-1 planar portion 551 and the 5-2 planar portion 553 may be in close contact with the inner wall surface near the corner of the battery case 590, the fifth corner portion 555 may be in close contact with the corner of the battery case 590, and the fifth curved portion 557 may be in close contact with the round corner of the electrode assembly 510.

The bottom elastic body 570 may include an elastic support plate 571, an electrolyte inlet hole 573, an arc debris movement path 575, and an arc debris storage recess 577.

The elastic support plate 571 is provided with a fifth corner elastic body 550 fixed vertically at each of the four corners and is curved to be convex upwardly to elastically support the electrode assembly 510 inserted into the battery case 590 toward the cap plate 530.

The electrolyte inlet hole 573 is evenly formed in plural across the entire surface in a perforated manner in the elastic support plate 571, so that the electrolyte injected into the battery case 590 rises from a bottom surface, and here, the electrolyte inlet holes 573 help the electrolyte slowly injected into the electrode assembly 510 from the bottom to rise, while passing through the electrolyte inlet holes 573.

The arc debris movement path 575 is formed in a groove shape extending in a first direction on an upper surface of the elastic support plate 571, and when arc debris occurring in the electrode assembly 510 falls to the bottom of the electrode assembly 510 due to gravity during the repeated charging and discharging of the complete secondary battery, the arc debris movement path 575 may allow the arc debris to not stay at the bottom of the electrode assembly 510 but move to both corners. Here, the arc debris movement path 575 is designed to go down from the center to both edges, thereby helping the arc debris to move to both edges more easily.

The arc debris storage recess 577 is provided at the corner of the elastic support plate 571 on which the fifth corner elastic body 550 is provided, and the arc debris flowing down through the arc debris movement path 575 gradually gathers and accumulates in the arc debris storage recess 577.

When the electrode assembly 510 fitted into the bottom elastic body 570 is entirely inserted into the battery case 170, as shown in FIG. 14, the fifth corner elastic body 550 may be in close contact with the internal edges of the battery case 590, and the electrode assembly 510 may be in close contact with the inner wall surface of the battery case 590 with the four corners fitted into the fifth corner elastic body 550. In addition, the bottom elastic body 570 may elastically support the electrode assembly 510 upwardly as the central portion of the elastic support plate 571 is in close contact with the electrode assembly 510.

According to the secondary battery according to an embodiment of the present disclosure, since the empty space occurring between the electrode assembly and the corner of the internal surface of the battery case is elastically filled by the corner elastic body, the electrode assembly may be prevented from moving due to external strong and irregularly repeated impact loads that may occur due to an operation of a vehicle, etc.

In addition, according to the secondary battery according to an embodiment of the present disclosure, since the bottom elastic body is provided between the electrode assembly and the inner bottom surface of the battery case, the electrode assembly may be elastically supported in the vertical direction.

However, the technical effects that may be obtained through the embodiments of the present disclosure are not necessarily limited to the effects mentioned above. Other technical effects that are not mentioned may be clearly understood by those skilled in the art from other descriptions of the specification, such as the detailed description.

Although the secondary battery having the function of preventing a movement and elastically supporting the electrode assembly has been described with reference to the embodiments of the present disclosure, it is obvious to those skilled in the art that various changes, modifications, or alterations may be made without departing from the spirit of the present disclosure.

What is claimed is:

1. A secondary battery comprising:
an electrode assembly including a positive electrode, a negative electrode, and a separator isolating the positive electrode and the negative electrode from each other;
a battery case having an accommodation space accommodating the electrode assembly and including at least one opening;
a cap plate coupled to the battery case to form the accommodation space; and
a corner elastic member, having a rod shape, provided to be fixed to each of four corners of the cap plate, and formed of an elastic material.

2. The secondary battery of claim 1, wherein the corner elastic body has a shape and size corresponding to a space occurring between the electrode assembly and an internal corner wall of the battery case.

3. The secondary battery of claim 2, wherein
the corner elastic body includes a first corner elastic body, and
the first corner elastic body includes a 1-1 planar portion which is a short section in a first direction, a 1-2 planar portion which is a short section in a second direction, a first corner portion which is a bent section between the 1-1 planar portion and the 1-2 planar portion, and a first curved portion which is a curved section between the 1-1 planar portion and the 1-2 planar portion.

4. The secondary battery of claim 3, wherein, when the electrode assembly fitted into the first corner elastic body is entirely inserted into the battery case, the 1-1 planar portion and the 1-2 planar portion are in close contact with the inner wall surface near the corner of the battery case, the first corner portion is in close contact with the corner of the battery case, and the first curved portion is in close contact with a round corner of the electrode assembly.

5. The secondary battery of claim 2, wherein
the corner elastic body includes a second corner elastic body, and
the second corner elastic body includes a 2-1 planar portion which is a short section in the first direction, a 2-2 planar portion which is a long section in the second direction, a second corner portion which is a bent section between the 2-1 planar portion and the 2-2 planar portion, and a pair of second curved portions which are curved sections between the 2-1 planar portion and the 2-2 planar portion.

6. The secondary battery of claim 5, wherein, when the electrode assembly fitted into the second corner elastic body is entirely inserted into the battery case, the 2-1 planar portion and the 2-2 planar portion are in close contact with the inner wall surface near the corner of the battery case, the second corner portion is in close contact with the corner of the battery case, and the second curved portion is in close contact with a round corner of the electrode assembly.

7. The secondary battery of claim 2, wherein
the corner elastic body includes a third corner elastic body, and
the third corner elastic body includes a 3-1 planar portion which is a short section in the first direction, a 3-2 planar portion which is a long section in the second direction, a third corner portion which is a bent section between the 3-1 planar portion and the 3-2 planar portion, a pair of third curved portions which are curved sections between the 3-1 planar portion and the 3-2 planar portion, and an inclined portion cut toward the end.

8. The secondary battery of claim 7, wherein the inclined portion has a function to facilitate initial insertion when the third corner elastic body with the electrode assembly fitted therein is inserted into the battery case.

9. The secondary battery of claim 7, wherein, when the electrode assembly fitted into the third corner elastic body is entirely inserted into the battery case, the 3-1 planar portion and the 3-2 planar portion are in close contact with the inner wall surface near the corner of the battery case, the third corner portion is in close contact with the corner of the battery case, and the third curved portion is in close contact with a round corner of the electrode assembly.

10. The secondary battery of claim 2, wherein
the corner elastic body includes a fourth corner elastic body, and
the fourth corner elastic body includes a 4-1 planar portion which is a short section in the first direction, a 4-2 planar portion which is a long section in the second direction, a fourth corner portion which is a bent section between the 4-1 planar portion and the 4-2 planar portion, a pair of fourth curved portions which are curved sections between the 4-1 planar portion and the 4-2 planar portion, and an uneven portion which is a section in which depressions and protrusions are densely formed on an internal surface of the fourth curved portion.

11. The secondary battery of claim 10, wherein the uneven portion has a function of increasing adhesion to facilitate insertion when the fourth corner elastic body with the electrode assembly fitted therein is inserted into the battery case.

12. The secondary battery of claim 10, wherein, when the electrode assembly fitted into the fourth corner elastic body is entirely inserted into the battery case with, the 4-1 planar portion and the 4-2 planar portion are in close contact with the inner wall surface near the corner of the battery case, the fourth corner portion is in close contact with the corner of the battery case, and the fourth curved portion is in close contact with a round corner of the electrode assembly.

13. A secondary battery comprising:
an electrode assembly including a positive electrode, a negative electrode, and a separator, and wherein a positive electrode tab electrically connected to the positive electrode and a negative electrode tab electrically connected to the negative electrode are provided to protrude;
a cap plate in which a vent is formed, a positive electrode terminal and a negative electrode terminal are provided on both sides of the vent, and an electrolyte injection port is formed between the vent and the positive electrode terminal or between the vent and the negative electrode terminal;
a fifth corner elastic body having a rod shape and formed of an elastic material;
a bottom elastic body including an elastic support plate provided so that the fifth corner elastic body is fixed to four corners in a vertical direction; and
a battery case in which an internal space is secured in which the electrode assembly and an electrolyte are accommodated together and an upper end of the battery case is open to form an opening.

14. The secondary battery of claim 13, wherein the fifth corner elastic body includes a 5-1 planar portion which is a short section in the first direction, a 5-2 planar portion which is a short section in the second direction, a fifth corner portion which is a bent section between the 5-1 planar portion and the 5-2 planar portion, and a fifth curved portion which is a curved section between the 5-1 planar portion and the 5-2 planar portion.

15. The secondary battery of claim 14, wherein, when the electrode assembly fitted into the fifth corner elastic body is entirely inserted into the battery case, the 5-1 planar portion and the 5-2 planar portion are in close contact with the inner wall surface near the corner of the battery case, the fifth corner portion is in close contact with the corner of the battery case, and the fifth curved portion is in close contact with a round corner of the electrode assembly.

16. The secondary battery of claim 13, wherein the elastic support plate is curved to be convex upwardly.

17. The secondary battery of claim 13, wherein the bottom elastic body further includes an electrolyte inlet hole, an arc debris movement path, and an arc debris storage recess.

18. The secondary battery of claim 17, wherein the electrolyte inlet hole is provided in plural and the plurality of electrolyte inlet holes are formed evenly in a perforated manner across the entire surface of the elastic support plate.

19. The secondary battery of claim 17, wherein the arc debris movement path is formed in a groove shape extending in a first direction on an upper surface of the elastic support plate.

20. The secondary battery of claim 17, wherein the arc debris storage recess is provided in a corner of the elastic support plate in which the fifth corner elastic body is provided.
